(19) United States
(12) Patent Application Publication
(10) Pub. No.: US 2025/0111177 A1
(43) Pub. Date: Apr. 3, 2025

(54) VEHICLE NFC PARKING CARD EQUIPPED WITH NFC CHIP AND NFC PARKING CARD APPLICATION SYSTEM FOR CONTACTING DRIVER BY TAGGING NFC

(71) Applicant: Min Kyu KIM, Incheon (KR)

(72) Inventor: Min Kyu KIM, Incheon (KR)

(21) Appl. No.: 18/728,791

(22) PCT Filed: Jul. 19, 2022
(86) PCT No.: PCT/KR2022/010481

§ 371 Date: Jul. 12, 2024

(30) Foreign Application Priority Data
Jan. 14, 2022 (KR) 10-2022-0005771

(51) Int. Cl. G06K 7/10

(52) U.S. Cl. CPC G06K 7/10297

(57) ABSTRACT

The present invention relates to a vehicle NFC parking card equipped with an NFC chip and an NFC parking card application system for contacting a driver by tagging NFC, and a method by which a caller contacts a driver by using an NFC parking card equipped with an NFC chip, which is installed in a vehicle, according to an embodiment of the present invention, comprises: when the caller tags the NFC parking card and accesses an NFC parking card application, sharing a unique identification number of the NFC parking card with the NFC parking card application so that driver information matching the tagged NFC parking card can be retrieved from a DB; searching the DB for a license plate number by using the shared unique identification number as a DB search value; retrieving the license plate number; sharing the retrieved license plate number with the caller; confirming, by the caller, the shared license plate number; transmitting a connection request to the driver; if the driver confirms and accepts the connection request of the caller, then retrieving, from the DB, a contact number of the driver by using the shared unique identification: B search value; and connecting the caller and the driver.

### TECHNICAL FIELD

The present invention relates to a vehicle NFC parking card equipped with an NFC chip installed in a vehicle and an NFC parking card application system for allowing a caller to make contact with a driver of the corresponding vehicle by tagging the NFC parking card installed in the vehicle.

### BACKGROUND ART

Currently, a parking number plate for a vehicle refers to an accessory for a vehicle which is installed with a contact number of a driver marked thereon so that the driver may be contacted in his/her absence or when there is no person who may make contact with the driver inside the vehicle or near the parked vehicle.

Since the conventional parking number plate is installed in a state in which the driver's contact number is always exposed, there is a problem that the contact number may be abused for crimes due to leakage of personal information.

In addition, the conventional number plate has a problem in that it is difficult to accurately make contact with the driver of the corresponding vehicle when the marked contact number is poorly readable.

In addition, when the contact number of the driver is changed, the conventional parking number plate causes an inconvenience of correcting the marked contact number and reinstalling the parking number plate with the contact number corrected.

### DISCLOSURE

### Technical Problem

The present invention has been applied to solve a personal information security problem of a conventional parking number plate, in which a contact number of a driver is always exposed, and an object of the present invention is to protect personal information and to prevent crimes caused by the leakage of personal information.

The present invention has been applied to solve a readability problem of the conventional parking number plate, and another object of the present invention is to make contact with the driver of the corresponding vehicle by tagging the NFC parking card installed in the vehicle regardless of the readability of the contact number.

The present invention has been applied to solve a problem of the conventional parking number plate, which causes an inconvenience of correcting the marked contact number and reinstalling the parking number plate, when the contact number of the driver is changed, and still another object of the present invention is to conveniently correct the contact number of the driver who may be contacted without a physical change of the NFC parking card installed in a vehicle by correcting the contact number registered in the NFC parking card application system described in the present invention when the contact number of the driver is changed.

### Technical Solution

To achieve the objects as described above, in a vehicle NFC parking card equipped with an NFC chip and an NFC parking card application system for making contact with a driver by tagging NFC according to one aspect of the present invention, a method for allowing a caller to make contact with a driver having an NFC parking card installed in a vehicle may include: scanning, by a caller, the NFC parking card installed in a vehicle, in which when the caller tags the NFC parking card, the caller is able to access the NFC parking card application and retrieve, from DB, a license plate number matching a unique identification number of the tagged NFC parking card; confirming, by the caller, the license plate number, in which the caller confirms the license plate number registered in the NFC parking card application by his/her own tagged NFC parking card; sending, by the caller, a connection request to the driver; retrieving a contact number of the driver, matching the unique identification number of the tagged NFC parking card, upon the driver's acceptance for the connection request from the caller; and connecting the caller and the driver.

### Advantageous Effects

The present invention relates to a vehicle NFC parking card equipped with an NFC chip and an NFC parking card application system for making contact with a driver by tagging NFC, and more specifically, to an NFC parking card installed in a vehicle, and an NFC parking card application system for allowing a caller to make contact with a driver by tagging an NFC parking card, in which the caller can make contact with the driver by tagging the NFC parking card regardless of readability of the NFC parking card, while the driver can have only the NFC parking card exposed without his/her own contact number marked, thereby protecting personal information, and preventing crimes caused by the leakage of personal information by making contact only through a tag of the NFC parking card installed in the vehicle.

In addition, when the contact number of the driver is changed, the contact number registered in the NFC parking card application can be corrected without physical correction of the NFC parking card installed in the vehicle, thereby allowing the changing of the contact number of the driver who may be contacted in association with the NFC parking card.

### DESCRIPTION OF DRAWINGS

FIG. 1 is a view of showing a configuration of a vehicle NFC parking card using NFC technology and an NFC parking card application system for making contact with a driver by tagging the NFC card according to one embodiment of the present invention. FIG. 1 is a view of showing a configuration of a vehicle NFC parking card using NFC technology and an NFC parking card application system for making contact with a driver by tagging the NFC card according to one embodiment of the present invention. FIG. 2 is a flowchart for explaining an example of a vehicle NFC parking card using NFC technology and an NFC parking card application system for making contact with a driver by tagging the NFC parking card according to one embodiment of the present invention. FIG. 2 is a flowchart for explaining an example of a vehicle NFC parking card using NFC technology and an NFC parking card application system for making contact with a driver by tagging the NFC parking card according to one embodiment of the present invention.

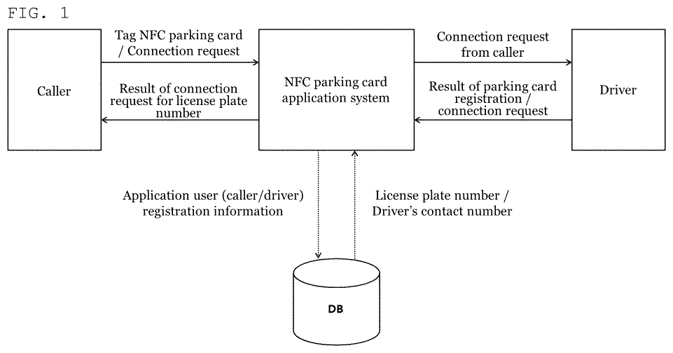

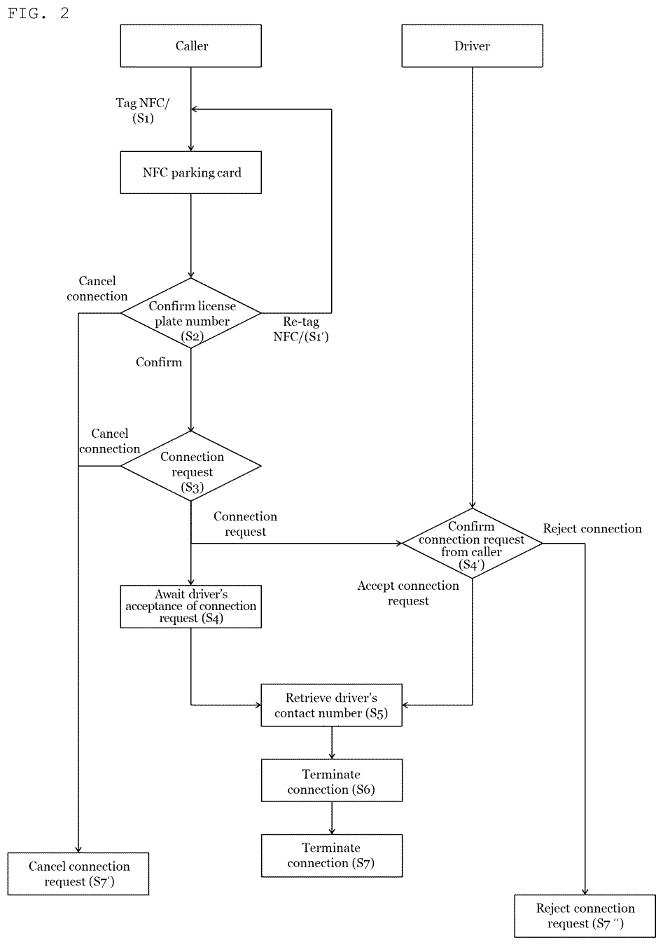

### MODE FOR INVENTION

Hereinafter, preferred embodiments of the present invention will be described in detail with reference to the accompanying drawings.

Referring to FIG. 2, a vehicle NFC parking card equipped with an NFC chip and an NFC parking card application system for making contact with a driver by tagging NFC may include: a card unit equipped with an NFC chip 101 and configured to receive a unique identification number 102 which is not redundant; and an application unit including an NFC parking card application 200 and DB 210.

The NFC chip 101 may be embedded in an NFC parking card 100, and a driver 104 may install the NFC parking card 100 at a position where a caller 103 easily tags the card when installing in the vehicle.

The unique identification number 102 may refer to the number which is given to the NFC parking card 100 to be different from the number of other NFC parking cards, and may be stored in DB 210 along with driver information 211 including a license plate number 212 and a contact number 213 of the driver. When the caller 103 tags the NFC parking card 100, the NFC parking card application 200 may be accessed to retrieve, from the DB 210, the license plate number 212 and the contact number 213 of the driver according to stage of making contact between the caller 103 and the driver 104, driver information 211 may be retrieved in such a way that the unique identification number 102 of the tagged NFC parking card 100 is a search value of DB 210.

In addition, the caller 103 may tag the NFC parking card 100 installed in the vehicle, thereby accessing the NFC parking card application 200, retrieving, from DB 210, the license plate number 212 and the contact number 213 of the driver, which match the unique identification number 102 of the tagged NFC parking card 100, sending, by the caller, a connection request to the driver 104, and making a connection between the caller 103 and the driver 104 when the driver 104 accepts the connection request.

Referring to FIG. 3, the method may include: S1 of tagging, by the caller 103, the NFC parking card 100 installed in a vehicle to access the NFC parking card application 200; S2 of retrieving, from DB 210, the license plate number 212 matching the unique identification number 102 of the tagged NFC parking card 100 and confirming, by the caller 103, the license plate number 212 registered in the NFC parking card application 200 through the tagged NFC parking card 100; S3 of sending, by the caller 103, a connection request to the driver 104; S4 of awaiting, by the caller 103, acceptance for the connection request from the driver 104; S4′ of confirming, by the driver 104, the connection request from the caller 103; S5 of accepting, by the driver 104, the connection request from the caller 103 and retrieving, from the DB 210, the driver's contact number 213 matching the unique identification number 102 of the NFC parking card 100; S6 of making contact by making a connection between the caller and the driver; and S7 of terminating the connection.

In this case, the caller 103 may select S1′ of re-tagging the NFC parking card in S2 of confirming the license plate number 212.

In addition, the caller 103 may cancel the connection request by selecting S7′ of canceling the connection request to the driver 104 in S2 of confirming the license plate number 212 and S4 of awaiting the acceptance for the connection request from the driver 104.

Furthermore, the driver 104 may select step S7″ of rejecting the connection request in S4′ of confirming the connection request from the caller 103.

1. (canceled)

2. A vehicle NFC parking card apparatus equipped with an NFC chip, wherein a vehicle apparatus is installed at a location for a caller to easily tag an NFC parking card, in which the caller tags the NFC parking card installed in a vehicle to access an NFC parking card application and retrieve, from DB, driver information matching the NFC parking card according to stages of making a connection between the caller and the driver.

3. A method for allowing a caller to make contact with a driver by using an NFC parking card, the method comprising:
tagging, by a caller, an NFC parking card installed in a vehicle to access an NFC parking card application;
sharing a license plate number of the NFC parking card registered in DB with the caller, and confirming, by the caller, the shared license plate number;
sending, by the caller, a connection request to the driver;
awaiting, by the caller, a driver's acceptance for the connection request, and selecting, by the driver, the connection request from the caller;
preparing a connection between the driver and the caller; and
making a connection between the caller and the driver.

4. (canceled)
